(19) United States
(12) Patent Application Publication
(10) Pub. No.: US 2010/0176711 A1
(43) Pub. Date: Jul. 15, 2010

(54) Light Emission Device

(76) Inventors: Dong-Su Chang, Suwon-si (KR); Hyeong-Rae Seon, Suwon-si (KR); Kyung-Sun Ryu, Suwon-si (KR)

Correspondence Address: CHRISTIE, PARKER & HALE, LLP, PO BOX 7068, PASADENA, CA, 91109-7068, US

(21) Appl. No.: 12/686,932

(22) Filed: Jan. 13, 2010

(30) Foreign Application Priority Data
Jan. 14, 2009 (KR) 10-2009-0003001

(51) Int. Cl. H01J 1/62

(52) U.S. Cl. 313/495

(57) ABSTRACT

A light emission device includes a first substrate having a plurality of recesses having a longitudinal axis extending in a first direction on a front surface of the first substrate; a first electrode in each of the plurality of recesses and having a longitudinal axis extending in the first direction; an electron emission part on the first electrode; a plurality of second electrodes extending in a second direction and crossing the plurality of recesses; a second substrate facing the first substrate; a third electrode and a phosphor layer on a rear surface of the second substrate facing the first substrate; an adhesive member on the second electrode and on the front surface of the first substrate; and a spacer contacting the adhesive member to maintain a space between the first and second substrates.

### CROSS-REFERENCE TO RELATED APPLICATION

This application claims priority to and the benefit of Korean Patent Application No. 10-2009-0003001 filed in the Korean Intellectual Property Office on Jan. 14, 2009, the entire content of which is incorporated herein by reference.

### BACKGROUND

1. Field

The described technology relates generally to a light emission device and a display device having the same, and more particularly, to a light emission device using a field emission principle and a display device having the same.

2. Description of the Related Art

Some light emission devices that emit light use a field emission principle. For example, a light emission device including a front substrate having a phosphor layer and an anode electrode and a rear substrate having an electron emission part and a driving electrode is known among various types of light emission devices using such a field emission principle. In the light emission device, the edges of the front substrate and the rear substrate are integrally attached by a sealing member, and then the internal space therebetween is exhausted to constitute a vacuum container along with the sealing member.

The driving electrode includes a cathode electrode and a gate electrode separately formed on the cathode electrode along a direction in which the gate electrode crosses the cathode electrode. An opening is formed at the gate electrode at every crossing of the cathode electrode and the gate electrode, and the electron emission part is located to be separate from the gate electrode on the cathode electrode.

With such a configuration, when a certain driving voltage is applied to the cathode electrode and the gate electrode, an electric field is formed around the electron emission part due to a voltage difference between the two electrodes, forcing electrons to be emitted from the electron emission part. The emitted electrons are attracted by a high voltage that is applied to the anode electrode to collide with the phosphor layer to excite the phosphor layer, and accordingly the phosphor layer emits visible light.

In some devices, in order to separate the electron emission part from the gate electrode and effectively minimize a spread angle of the electrons emitted from the electron emission part, a structure is employed in which a recess is formed on the rear substrate and the cathode electrode and the electron emission part are located in the recess.

However, such a structure has a problem in that it is difficult to fix the gate electrode at an accurate position such that the openings correspond to the electron emission part. In addition, unless the gate electrode is stably fixed, noise may be generated due to vibration caused by a driving frequency, and uneven height of the openings would result in a non-uniformity of luminance.

Also, if the space between the front and rear substrates is not stably maintained, light emitted from the light emission device may become inferior.

The above information disclosed in this Background section is only for enhancement of understanding of the background of the described technology and therefore it may contain information that does not form the prior art that is already known in this country to a person of ordinary skill in the art.

### SUMMARY

The described technology has been made in an effort to provide a light emission device with reduced generation of noise, improving light quality, and effectively maintaining a space between two substrates.

In one embodiment, a light emission device is provided including a first substrate comprising a plurality of recesses having a longitudinal axis extending in a first direction on a front surface of the first substrate; a first electrode in each of the plurality of recesses and having a longitudinal axis extending in the first direction; an electron emission part on the first electrode; a plurality of second electrodes extending in a second direction and crossing the plurality of recesses; a second substrate facing the first substrate; a third electrode and a phosphor layer on a rear surface of the second substrate facing the first substrate; an adhesive member on the second electrode and on the front surface of the first substrate; and a spacer contacting the adhesive member to maintain a space between the first and second substrates.

In one embodiment, a rear surface of the second electrode is attached to the front surface of the first substrate, and the adhesive member is in contact with the front surface of the first substrate and with a front surface and a side surface of the second electrode. Further, the adhesive member may be located on and between the edges of adjacent second electrodes of the plurality of second electrodes.

In one embodiment, the second electrode has a through hole located adjacent the front surface of the first substrate, and wherein the adhesive member is in the through hole. Additionally, an oxide film may be on the surface of the second electrode and is in contact with the adhesive member. Further, in one embodiment, the second electrode includes a metal plate having a thickness greater than a thickness of the first electrode, the metal plate having a mesh portion located on the electron emission part at a region where the second electrode crosses the first electrode and a support portion around the mesh portion and contacting the first substrate, and the adhesive member contacts the support portion of the second electrode. The mesh portion may include a plurality of openings configured to allow electrons emitted from the electron emission part to pass therethrough. In one embodiment, the spacer is located directly on the adhesive member. Further, an end portion of the spacer may contact the front surface of the first substrate, and the adhesive member may cover the end portion of the spacer.

In one embodiment, each of the plurality of recesses has a width greater than a width of the first electrode, and has a depth greater than a sum of the thicknesses of the first electrode and the electron emission part. Further, in one embodiment, adjacent ones of the plurality of recesses are spaced from each other by a portion of the first substrate acting as a barrier rib demarcating the first electrode in a first recess of the plurality of recesses from the first electrode in an adjacent second recess of the plurality of recesses, and wherein the second electrodes are separate from the electron emission parts.

### BRIEF DESCRIPTION OF THE DRAWINGS

FIG. 1 is a partial cut-away perspective view of the light emission device according to a first exemplary embodiment.

FIG. 2 is a partial cross-sectional view of the light emission device of FIG. 1.

FIG. 3 is another partial cross-sectional view of the light emission device of FIG. 1.

FIG. 4 is a partial cut-away sectional view of a light emission device according to a second exemplary embodiment.

FIG. 5 is a partial cut-away perspective view of a light emission device according to a third exemplary embodiment.

FIG. 6 is an exploded perspective view of a display device comprising the light emission device of FIG. 1.

FIG. 7 is a partial cross-sectional view of a display panel of FIG. 6.

### DETAILED DESCRIPTION

Embodiments will be described more fully hereinafter with reference to the accompanying drawings, in which exemplary embodiments are shown. As those skilled in the art would realize, the described embodiments may be modified in various different ways, all without departing from the spirit or scope of an embodiment.

In describing the exemplary embodiments, the same reference numerals are used for the elements having the same constructions and representatively described in a first exemplary embodiment, and in remaining exemplary embodiments, different constructions from those of the first exemplary embodiment will be described.

In order to clarify an embodiment, parts that are not connected with the description will be omitted, and the same elements or equivalents are referred to by the same reference numerals throughout the specification.

The size and thickness of each element are arbitrarily shown in the drawings, and an embodiment is not necessarily limited thereto.

In the drawings, the thickness of layers, films, panels, regions, etc., are exaggerated for clarity. Also, in the drawings, the thickness of some layers and regions are exaggerated for the sake of brevity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

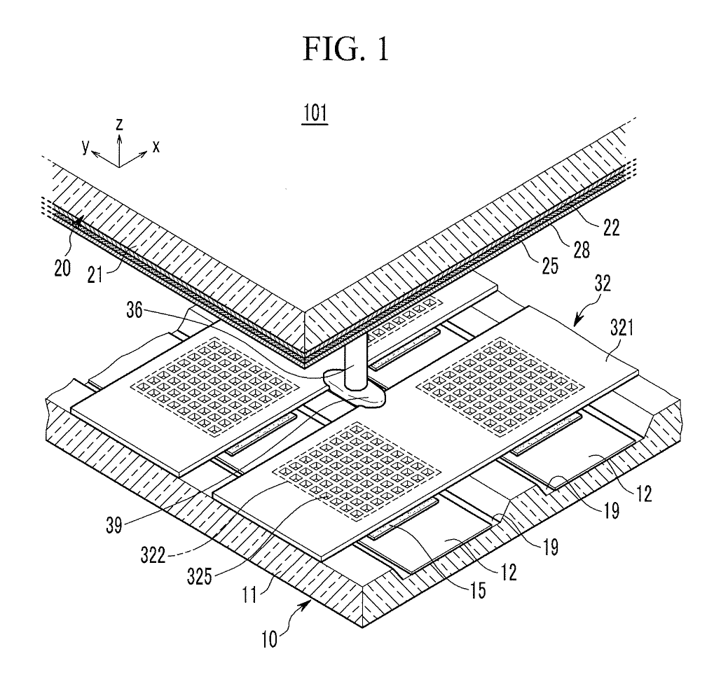

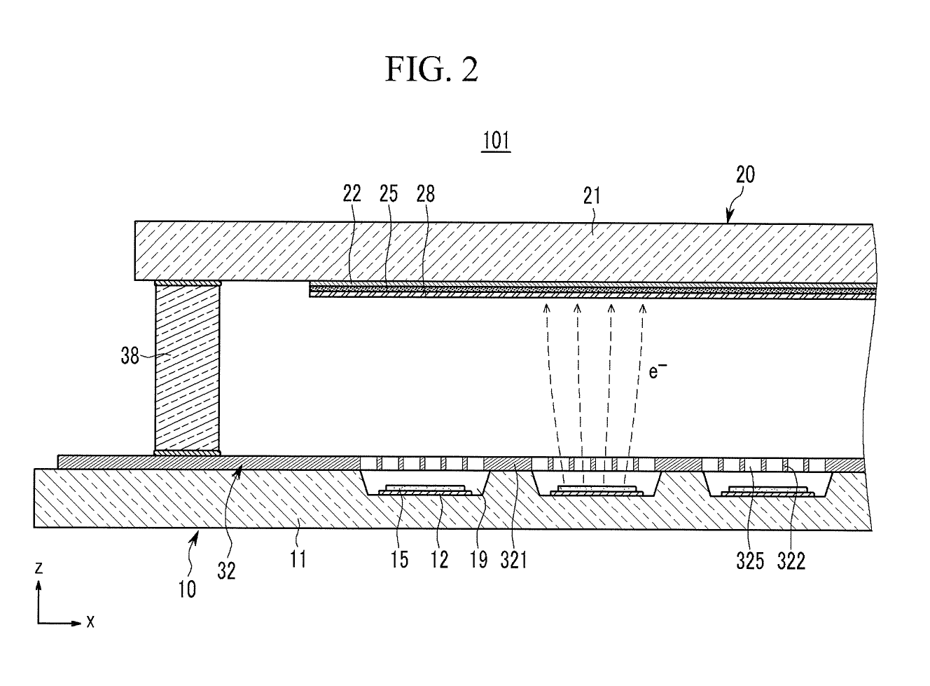

A light emission device 101 according to a first exemplary embodiment will now be described with reference to FIGS. 1 and 2.

As shown in FIG. 1, the light emission device 101 according to the first exemplary embodiment includes a first substrate 10, a second substrate 20 located to face the first substrate 10, a spacer 36 located between the first and second substrates 10 and 20 to maintain a space between the substrates 10 and 20, and a sealing member (38, see FIG. 2) located on edges of the first and second substrates 10 and 20 to attach and seal the substrates 10 and 20 together. The interior of the first substrate 10, the second substrate 20, and the sealing member 38 is vacuumized in which a vacuum degree of substantially 10⁻⁶ Torr is maintained.

The first substrate 10 includes a first substrate main body 11, first electrodes 12, electron emission parts 15, second electrodes 32, and an adhesive member 39. Here, the first electrodes 12 are cathode electrodes, and the second electrodes 32 are gate electrodes. However, the first exemplary embodiment is not limited thereto, and the first electrodes 12 may be gate electrodes while the second electrodes 32 may be cathodes.

The first substrate main body 11 includes recesses 19 formed in a stripe pattern on portions of a front surface thereof. The recesses 19 are formed by removing portions of the first substrate main body 11 by using methods such as etching, sand blasting, and the like. In FIGS. 1 and 2, the recesses 19 of the first substrate main body 11 are formed to have inclined side walls, but an embodiment is not limited thereto. That is, the recesses 19 of the first substrate main body 11 may have vertical side walls.

As an example, the first substrate main body 11 may have a thickness of about 1.8 mm. The recesses 19 may be formed to have a depth of about 40 μm and a width ranging from 300 μm to 600 μm.

The first electrodes 12 are located on the bottom within the recesses 19 of the first substrate main body 11. In this case, the first electrodes 12 are formed in a stripe pattern in the direction (i.e., y-axis direction) parallel to the recesses 19. Accordingly, the lengthwise direction of the first electrodes 12 is the same as the lengthwise direction of the recesses 19. The portion of the first substrate main body 11 between the recesses 19 serves as a barrier rib demarcating neighboring first electrodes 12.

The second electrodes 32 are formed in a stripe pattern in a direction (i.e., x-axis direction) in which the second electrodes 32 cross the first electrodes 12, and are located directly on a front surface of the first substrate main body 11. Accordingly, the second electrodes 32 are separated substantially by the depth of the recesses 19 from the first electrodes 12 located within the recesses 19 of the first substrate main body 11.

The electron emission parts 15 are formed on the first electrodes 12 such that they are separated from (spaced from) the second electrodes 32. FIG. 1 shows the case where, as an example, the electron emission parts 15 are formed at the crossings of the first and second electrodes 12 and 32, but an embodiment is not limited thereto. That is, the electron emission parts 15 may be formed in a stripe pattern parallel to the first electrodes 12 on the first electrodes 12.

The electron emission parts 15 include materials, e.g., a carbon-based material or a nano-meter size material, that emit electrons when an electric field is applied thereto in a vacuum state. The electron emission parts 15 may include a material selected from the group consisting of, for example, carbon nanotubes (CNT), graphite, graphite nanofibers, diamond, diamond-like carbon (DLC), fullerene C₆₀, silicon nanowire, and any of their combinations.

The electron emission parts 15 may be formed as electron emission layers with a certain thickness through a thick film process such as screen printing. That is, the electron emission parts 15 may be formed through a process of screen-printing a paste-like mixture including electron emission materials on the first electrodes 12, drying and firing the printed mixture, and then activating the surface of the electron emission parts 15 such that the electron emission materials are exposed to the surface of the electron emission parts 15. The surface activation process may include attaching an adhesive tape and then detaching it. Through such surface activation process, the electron emission materials such as CNT can be positioned to be substantially perpendicular to the surfaces of the electron emission parts 15, while removing portions of the surfaces of the electron emission parts 15.

The adhesive member 39 is formed on and across the second electrodes 32 and on the front surface of the first substrate main body 11. In detail, rear surfaces of the second electrodes 32 are tightly attached to the front surface of the first substrate main body 11, and the adhesive member 39 is in contact with the front surface of the first substrate main body 11 and with the front and side surfaces of the second electrodes 32. That is, the adhesive member 39 is not located between the rear surfaces of the second electrodes 32 and the front surface of the first substrate main body 11.

The adhesive member 39 is made of frit or the like, and is formed on and between the edges of the neighboring second electrodes 32. That is, the adhesive member 39 may be formed by applying glass paste on the upper portions of the second electrodes 32 and on the front surface of the first substrate main body 11 and then firing the same.

In addition, the second electrodes 32 includes a mesh portion 322 separately formed at an upper side of the electron emission parts 15 at the region where the second electrodes 32 cross the first electrodes 12, and a support 321 surrounding the mesh portion 322 and being in contact with the first substrate main body 11. Here, the mesh portion 322 includes a plurality of openings 325 allowing electrons that have been emitted from the electron emission parts 15 to pass therethrough. The support 321 is in contact with the adhesive member 39.

In FIG. 1, the mesh portion 322 of the second electrode 32 is formed at the region where it crosses the first electrode 12, but an embodiment is not limited thereto. That is, the mesh portion 322 may be formed at a region where the second electrode 32 does not cross the first electrode 12, as well as at the region where the second electrode 32 crosses the first electrode 12. In that case, the process of aligning the second electrode 32 may have more leeway. Additionally, when the mesh portion 322 is formed at the region where the second electrode 32 crosses the first electrode 12, line resistance of the second electrode 32 can be reduced to suppress a voltage drop of the second electrode 32 when driving is performed.

In addition, the second electrode 32 is fabricated with a metal plate having a larger thickness than that of the first electrode 12. For example, the second electrode 32 may be fabricated by cutting a metal plate in a strip form and then forming the opening 325 by removing a portion of the metal plate through a method such as etching and the like.

The second electrode 32 may be made of a nickel-iron alloy or any other metal material, and may have a thickness of about 50 μm and a width of about 10 mm. The second electrode 32 is fabricated in a different process from that of the first electrode 12 and the electron emission part 15, and then fixed to the upper surface of the first substrate main body 11 along a direction in which the second electrode 32 crosses the first electrode 12. In this case, because the first electrode 12 and the electron emission part 15 are positioned within the recess 19 of the first substrate main body 11, simply fixing the second electrode 32 onto the upper surface of the first substrate main body 11 automatically ensures insulation between the first and second electrodes 12 and 32.

With such a configuration, the second electrode 32 may be stably fixed on the first substrate main body 11 by means of the adhesive member 39. Accordingly, the second electrode 32 including the mesh portion 322 can be restrained from being vibrated by a driving frequency, and thus noise generation can be suppressed. In addition, because the second electrode 32 is tightly attached to the first substrate main body 11, the openings 325 of the mesh portion 322 can be fixed to be even in their height, improving the uniformity of luminance. Therefore, the light emission device 101 can emit uniform light.

In one embodiment, the recess 19 is formed to be wider than the width of the first electrode 12, and has a depth greater than the sum of the thicknesses of the first electrode 12 and the electron emission part 15. Accordingly, the second electrode 32 can be stably separated from the first electrode 12 located within the recess 19 of the first substrate main body 11. That is, the first and second electrodes 12 and 32 are stably insulated from each other.

In addition, one of the crossings of the first electrodes 12 and the second electrodes 32 may be positioned at one pixel area of the light emission device 101, or two or more of the crossings of the first electrodes 12 and the second electrodes 32 may be positioned at one pixel area of the light emission device 101. In the latter case, the first electrodes 12 or the second electrodes 32 corresponding to a single pixel area may be electrically connected to receive the same voltage.

The second substrate 20 includes a second substrate main body 21, a third electrode 22, a phosphor layer 25, and a reflective layer 28. The third electrode 22, the phosphor layer 25, and the reflective layer 28 are sequentially formed on an inner surface of the second substrate main body 21 that faces the first substrate 10. That is, the third electrode 22, the phosphor layer 25, and the reflective layer 28 are arranged to become sequentially closer in this order to the second substrate main body 21. Here, the third electrode 22 is an anode electrode. The first and second substrate main bodies 11 and 21 may be made of a ceramic-based material such as, for example, glass.

The third electrode 22 may be made of a transparent conductive material such as indium tin oxide (ITO) to allow visible light emitted from the phosphor layer 25 to transmit therethrough. The third electrode 22, which is an acceleration electrode that attracts electrons, maintains the phosphor layer 25 in a high potential state upon receiving a positive DC voltage (referred to as an “anode voltage”, hereinafter) of more than thousands of volts.

The phosphor layer 25 may be a mixed phosphor formed by mixing red phosphor, green phosphor, and blue phosphor, therefore emitting white light. In FIGS. 1 and 2, the phosphor layer 25 is shown to be formed on the entire light emission area of the second substrate main body 21, but an embodiment is not meant to be limited thereto. That is, the phosphor layer 25 may be separately formed at each pixel area.

The reflective layer 28 may be formed as an aluminum thin film with a thickness of thousands of angstroms (Å), and may have fine holes allowing electrons to pass therethrough. The reflective layer 28 serves to reflect visible light emitted toward the first substrate 10, among visible light that has been emitted from the phosphor layer 25, to thereby enhance the luminance of the light emission device 101.

One of the third electrode 22 and the reflective layer 28 may be omitted. If the third electrode 22 is omitted, the reflective layer 28 may receive an anode voltage to perform the same function as that of the third electrode 22.

With such a configuration, an electric field is formed around the electron emission part 15 at pixels in which a voltage difference between the first and second electrodes 12 and 32 is a threshold value or larger, from which electrons are emitted. The emitted electrons are attracted by the anode voltage applied to the third electrode 22 to collide with the phosphor layer 25 portion to emit the corresponding phosphor layer 25. The luminance of the phosphor layer 25 of each pixel corresponds to the amount of emitted electrons of the each pixel.

As shown in FIG. 2, because the mesh portion 322 of the second electrode 32 is present over the electron emission part 15, electrons emitted from the electron emission part 15 can pass through the openings 325 of the mesh portion 322 such that beam spreading is minimized, to reach the phosphor 25. Thus, in the light emission device 101 according to the first exemplary embodiment, an initial spread angle of electrons can be reduced to effectively suppress charging of electric charges at the side walls of the recess 19.

As a result, the light emission device 101 according to the first exemplary embodiment can be stably driven by increasing the withstand voltage characteristics of the first and second electrodes 12 and 32, and can implement a high luminance by applying a high voltage of 10 kV or higher, and preferably a high voltage of 10 kV to 15 kV, to the third electrode 22.

In addition, in the light emission device 101 according to the first exemplary embodiment, a thick film process for formation of an insulating layer and thin film process for formation of the second electrode 32 as in the related art can be omitted, so the fabrication process can be simplified. Moreover, as mentioned above, the second electrodes 32 can be easily aligned, thereby improving the productivity.

Also, because the second electrodes 32 are incorporated after the electron emission parts 15 are formed, a problem in the related art of the first and second electrodes 12 and 32 being short-circuited due to a conductive electron emission material in the process of forming the electron emission parts 15 can be avoided.

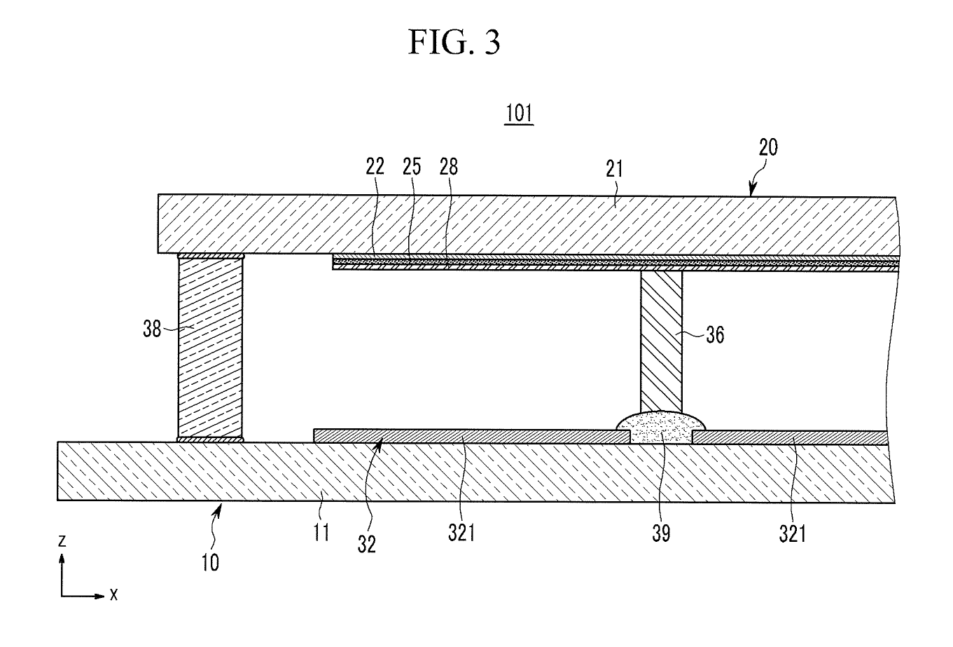

As shown in FIG. 3, the spacer 36, withstanding the vacuum pressure, uniformly maintains the space between the substrates 10 and 20. Here, the spacer 36 is located to be in contact with the adhesive member 39. That is, the adhesive member 39 serves to attach the first substrate main body 11 and the second electrode 32 and fix the spacer 36. In this case, the spacer 36 is located on the adhesive member 39.

With such a configuration, the spacer 36 can be stably fixed to maintain the space between the first and second substrate main bodies 11 and 21.

By having such structure and configuration as described above, the light emission device 101 can restrain generation of noise, improve light quality, and effectively maintain the space between the substrates 10 and 20.

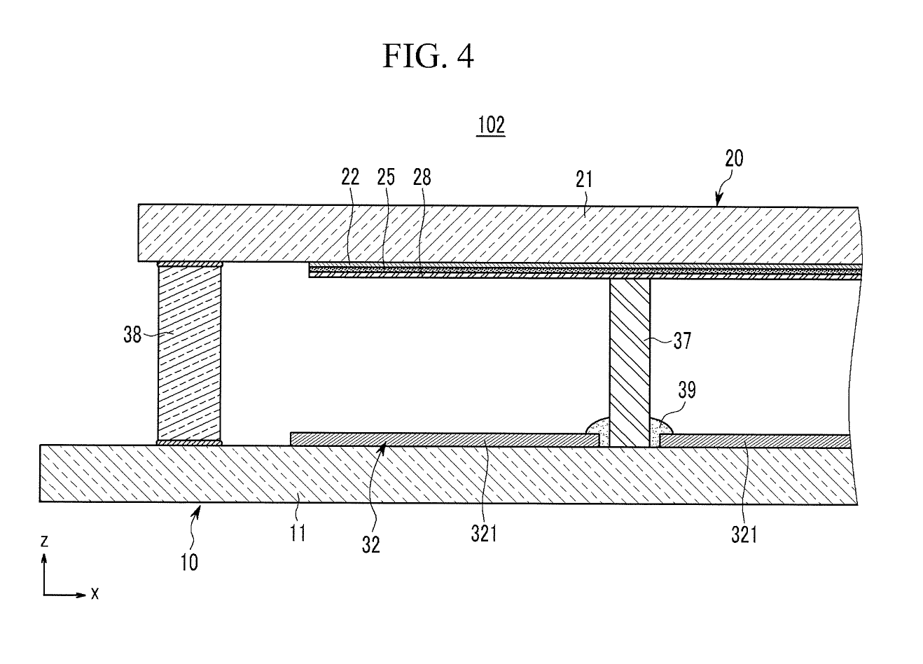

A light emission device 102 according to a second exemplary embodiment will now be described with reference to FIG. 4.

As shown in FIG. 4, in the light emission device 102 according to the second exemplary embodiment, one end portion of a spacer 37 is in direct contact with the front surface of the first substrate main body 11. The adhesive member 39 is located to surround the portion of the spacer 37 that is in direct contact with the front surface of the first substrate main body 11.

With such a configuration, the spacer 37 can more stably maintain the space between the first and second substrates 10 and 20. Referring to the light emission device 101 according to the first exemplary embodiment, the adhesive member 39 is in contact with the spacer 36 before it is completely hardened during the fabrication process, so it is possible for the adhesive member 39 to be deformed before being hardened. If the adhesive member 39 is deformed, the spacer 36 would deviate from its accurate position. Then, a gap might be generated between the outer end portion of the spacer facing the second substrate 20 and the second substrate 20. By contrast, however, in the light emission device 102 according to the second exemplary embodiment, because one end portion of the spacer 37 in contact with the adhesive member 39 is directly in contact with the first substrate main body 11, even if the adhesive member 39 is slightly deformed during the fabrication process, the spacer 37 can stably maintain the space between the first and second substrates 10 and 20.

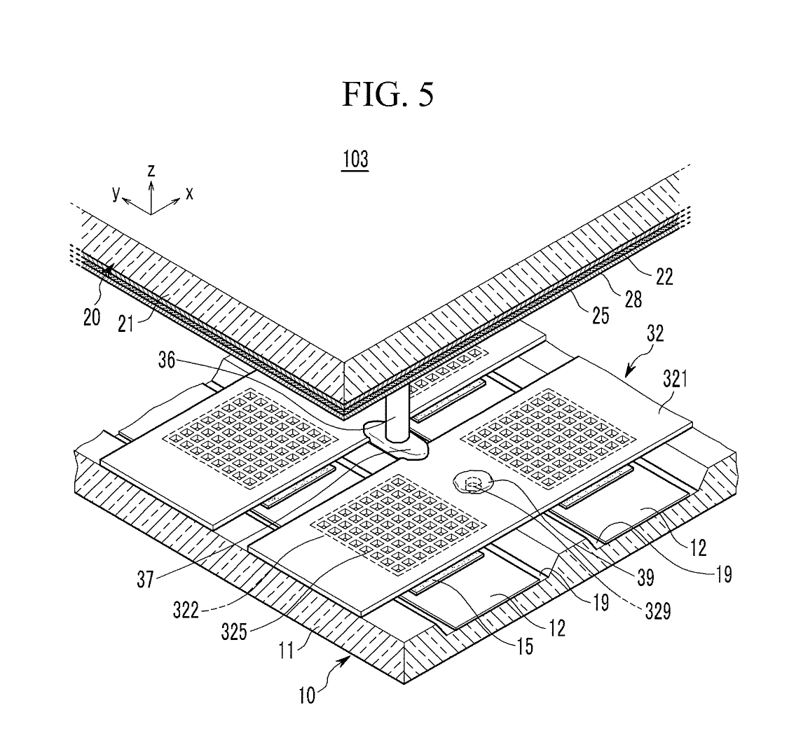

A light emission device 103 according to a third exemplary embodiment will now be described with reference to FIG. 5.

As shown in FIG. 5, the light emission device according to the third exemplary embodiment includes the second electrode 32 with a through hole 329 at a region in contact with the front surface of the first substrate main body 11. That is, the second electrode 32 includes the through hole 329 exposing the front surface of the first substrate main body 11. In detail, the through hole 329 is formed on the support 321 of the second electrode 32.

The adhesive member 39 is formed in the through hole 329 of the second electrode 32, and is brought into contact with the front surface of the first substrate main body 11 exposed through the through hole 329 and with the front and side surfaces of the second electrode 32.

In addition, an oxide film is formed on a partial surface of the second electrode 32 in contact with the adhesive member 39. Such oxide film may be formed by heating a portion of the surface of the second electrode 32, where the oxide film is to be formed, by using a laser. The adhesive strength is good between the adhesive member 39 and the first substrate main body 11, each being made of a ceramic-based material, while the adhesive strength between the adhesive member 39 and the second electrode 32 made of a metal is inferior. Further, the adhesive member 39 has better adhesive strength with a metal oxide film compared with a metal. Thus, the formation of the oxide film on a portion of the surface of the second electrode 32 in contact with the adhesive member 39 ensures that the second electrode 32 is stably and tightly fixed onto the first substrate main body 11.

With such a configuration, the adhesive member 39 can more stably fix the second electrode 32 on the first substrate main body 11.

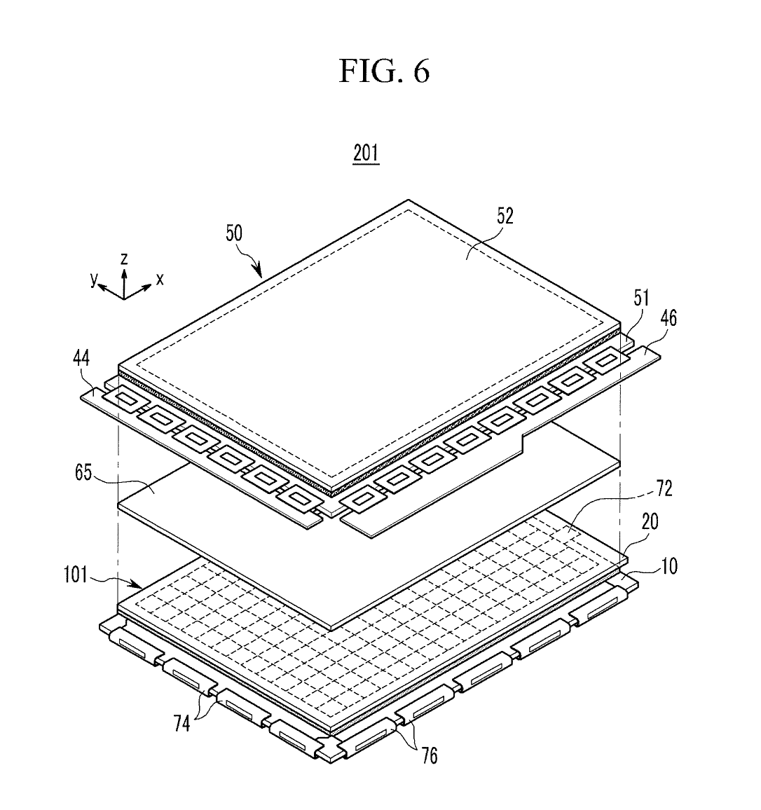

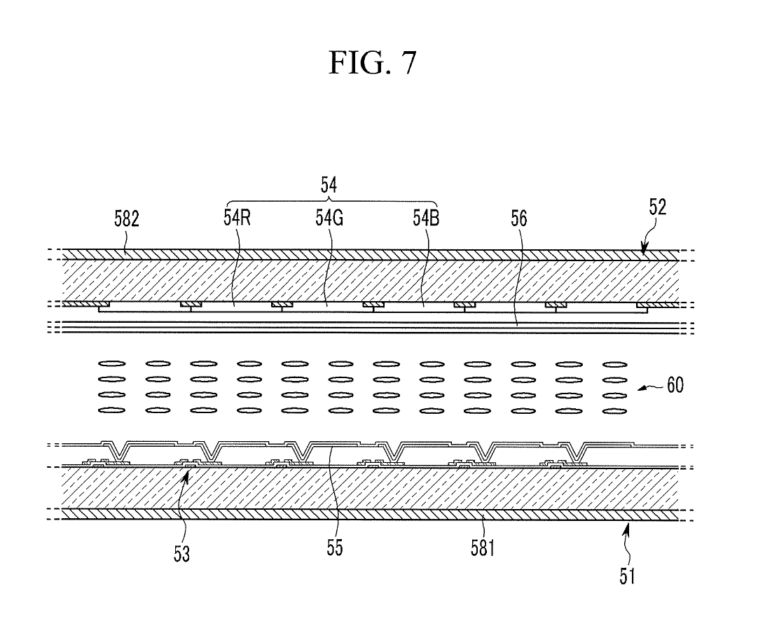

A display device 201 according to another exemplary embodiment will now be described with reference to FIGS. 6 and 7. The display device 201 according to an exemplary embodiment may include the light emission devices 101, 102, and 103 according to the first to third exemplary embodiments as described above. In the following description, the case where the display device 20 includes the light emission device 101 of FIG. 1 will be taken as an example.

As shown in FIG. 6, the display device 201 includes the light emission device 101 and a display panel 50 located in front of the light emission device 101. The display device 201 may further include a diffusion member 65 located between the light emission device 101 and the display panel 50 to evenly spread light emitted from the light emission device 101. In this case, the diffusion member 65 and the light emission device 101 are separated by a certain distance from each other. The display device 201 includes the light emission device 101 according to the first exemplary embodiment as a light source.

In FIGS. 6 and 7, a liquid crystal panel is employed as the display panel 50, but an embodiment is not limited thereto. That is, the display panel 50 can be any light receiving display panel.

As shown in FIG. 7, the display panel 50 includes a first display plate 51 having thin film transistors (TFTs) 53 and pixel electrodes 55, a second display plate 52 having a color filter layer 54 and a common electrode 56, and a liquid crystal layer 60 injected between the first and second display plates 51 and 52. Polarizers 581 and 582 are attached to a front surface of the first display plate 51 and a rear surface of the second display plate 52, respectively, to polarize light that passes through the display panel 50.

The pixel electrode 55 is positioned at every subpixel, and driving of the pixel electrode 55 is controlled by the TFT 53. Here, a plurality of subpixels implementing different colors constitute a single pixel, and the single pixel is a minimum unit for displaying an image. The pixel electrodes 55 and the common electrode 56 are made of a transparent conductive material. The color filter layer 54 includes a red filter layer 54R, a green filter layer 54G, and a blue filter layer 54B positioned at each subpixel.

When the TFT 53 of a particular subpixel is turned on, an electric field is formed between the pixel electrode 55 and the common electrode 56. An arrangement angle of liquid crystal molecules of the liquid crystal layer 60 changes due to the electric field, and light transmittance varies according to the changed arrangement angle of the liquid crystal molecules. Through such processes, the display panel 50 can control the luminance and a light emission color of each pixel to display an image.

The display panel 50 is not limited to the above-described structure, but can be variably modified with known configurations that can be easily carried out by the skilled person in the art.

As shown in FIG. 6, the display device 201 further includes a gate circuit board 44 for supplying a gate driving signal of a gate electrode of each TFT 53 of the display panel 50, and a data circuit board 46 for supplying a data driving signal to a source electrode of each TFT 53 of the display panel 50.

The light emission device 101 includes a smaller number of pixels than the display panel 50 so that one pixel of the light emission device 101 corresponds to two or more pixels of the display panel 50.

Each pixel of the light emission device 101 may emit light according to gray levels of the corresponding pixels of the display panel 50, and for example, each pixel may emit light correspondingly according to the highest one of the gray levels of the pixels of the display panel 50. Each pixel of the light emission device 101 may represent gray levels of 2 to 8 bits.

Hereinafter, the pixels of the display panel 50 will be referred to as first pixels, the pixels of the light emission device 101 will be referred to as second pixels, and first pixels corresponding to a single second pixel will be referred to as a first pixel group.

A driving process of the light emission device 101 may include detecting, by a signal controller that controls the display panel 50, the highest gray level of the first pixels of the first pixel group, calculating a gray level required for emitting the second pixels according to the detected gray level and converting the same into digital data, generating a drive signal of the light emission device 101 by using the digital data, and applying the generated drive signal to the driving electrode of the light emission device 101.

The drive signal of the light emission device 101 includes a scan signal and a data signal. One of the first and second electrodes 12 and 32 receives the scan signal while the other receives the data signal.

Although not shown, a data circuit board and a scan circuit board for driving the light emission device 101 may be located on the rear surface of the light emission device 101. The data circuit board and the scan circuit board are connected with the first and second electrodes 12 and 32 via first and second connectors 76 and 74, respectively. A third connector 72 applies an anode voltage to the third electrode 22.

In this manner, when an image is displayed at the first pixel group, the second pixels of the light emission device 101 are synchronized with the corresponding first pixel group to emit light with a certain gray level. That is, the light emission device 101 provides light of a high luminance to a relatively bright region of a screen image displayed on the display panel 50, and provides light of a low luminance to a relatively dark region of the screen image. Accordingly, the display device 201 according to an exemplary embodiment can increase the contrast ratio of the screen image and implement clearer picture quality.

With such a configuration, the display device 201 can include the light emission devices 101, 102, and 103 in which noise generation is restrained, light quality is improved, and the space between the both substrates 10 and 20 is effectively maintained.

In addition, the display device 201 can have uniform and further improved luminance.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A light emission device comprising:
a first substrate comprising a plurality of recesses having a longitudinal axis extending in a first direction on a front surface of the first substrate;
a first electrode in each of the plurality of recesses and having a longitudinal axis extending in the first direction;
an electron emission part on the first electrode;
a plurality of second electrodes extending in a second direction and crossing the plurality of recesses;
a second substrate facing the first substrate;
a third electrode and a phosphor layer on a rear surface of the second substrate facing the first substrate;
an adhesive member on the second electrode and on the front surface of the first substrate; and
a spacer contacting the adhesive member to maintain a space between the first and second substrates.

2. The device of claim 1, wherein a rear surface of the second electrode is attached to the front surface of the first substrate, and wherein the adhesive member contacts a front surface and a side surface of the second electrode.

3. The device of claim 2, wherein the adhesive member is located on and between the edges of adjacent second electrodes of the plurality of second electrodes.

4. The device of claim 2, wherein the second electrode has a through hole located adjacent the front surface of the first substrate, and wherein the adhesive member is in the through hole.

5. The device of claim 2, wherein an oxide film is on the surface of the second electrode and is in contact with the adhesive member.

6. The device of claim 2, wherein the second electrode comprises a metal plate having a thickness greater than a thickness of the first electrode, the metal plate having a mesh portion located on the electron emission part at a region where the second electrode crosses the first electrode and a support portion around the mesh portion and contacting the first substrate, and wherein the adhesive member contacts the support portion of the second electrode.

7. The device of claim 6, wherein the mesh portion comprises a plurality of openings configured to allow electrons emitted from the electron emission part to pass therethrough.

8. The device of claim 2, wherein the adhesive member comprises a frit.

9. The device of claim 2, wherein the spacer is located directly on the adhesive member.

10. The device of claim 2, wherein an end portion of the spacer contacts the front surface of the first substrate, and wherein the adhesive member covers the end portion of the spacer.

11. The device of claim 2, wherein each of the plurality of recesses has a width greater than a width of the first electrode, and has a depth greater than a sum of the thicknesses of the first electrode and the electron emission part.

12. The device of claim 2, wherein adjacent ones of the plurality of recesses are spaced from each other by a portion of the first substrate acting as a barrier rib demarcating the first electrode in a first recess of the plurality of recesses from the first electrode in an adjacent second recess of the plurality of recesses, and wherein the second electrodes are separate from the electron emission part.
